(19) United States
(12) Patent Application Publication
(10) Pub. No.: US 2014/0182560 A1
(43) Pub. Date: Jul. 3, 2014

(54) VARIABLE SPEED DUAL FUELED ENGINE AND ELECTRICAL POWER MANAGEMENT APPARATUS AND METHODS

(71) Applicant: GENERAL ELECTRIC COMPANY, Schenectady, NY (US)

(72) Inventors: Frank Veit, Cocoa, FL (US); Brandon Larson, Cincinnati, OH (US); Paul Gemin, Niskayuna, NY (US); Ramesh Krishnan, Ontario (CA); Martin Butcher, Warwickshire (GB); Roy Primus, Niskayuna, NY (US); Rekha Prasad, Sewickley, PA (US)

(73) Assignee: GENERAL ELECTRIC COMPANY, Schenectady, NY (US)

(21) Appl. No.: 14/101,717

(22) Filed: Dec. 10, 2013

Related U.S. Application Data
(60) Provisional application No. 61/747,329, filed on Dec. 30, 2012.

(51) Int. Cl. F02D 41/38

(52) U.S. Cl. CPC F02D 41/38
USPC 123/478

(57) ABSTRACT

A fuel system is provided for use with a variable speed dual fuel engine. The fuel system comprises a first fuel injector configured for supplying diesel fuel to the engine, a second fuel injector configured for supplying natural gas to the engine, and a fuel controller configured to implement a diesel injection schedule and a natural gas injection schedule based on at least a fuel map, an optimal engine speed and a current engine speed.

### CROSS REFERENCE TO RELATED APPLICATIONS

This application claims the benefit of U.S. Provisional App. No. 61/747,329, filed Dec. 30, 2012, which is hereby incorporated by reference in its entirety.

### BACKGROUND

1. Technical Field

Embodiments of the invention relate generally to power generation and distribution. Other embodiments relate to power generation using a dual fueled engine (e.g., diesel and liquid natural gas) and a variable speed generator.

2. Discussion of Art

Compression ignition engines (e.g., diesel engines) are a type of internal combustion engine which use heat of compression to initiate ignition and burn fuel. Compression ignition engines may have a higher thermal efficiency than other internal combustion engines, such as spark ignition engines, for example. However, compression ignition engines may have increased emissions (e.g., nitrogen oxides (NOx), particulates, or the like), as compared to other internal combustion engines. The increased amount of NOx is attributed to diffusion flame combustion. In the diffusion flame, fuel is oxidized in a stoichiometric fashion which produces relatively high local temperatures. The high local temperatures produce increased levels of NOx. Further, the increased particulate emissions are based upon the heterogeneous combustion event in which local equivalence ratios are high and a tendency for particulate formation increases. As such, an exhaust gas treatment system may be coupled to an exhaust passage of the engine in order to reduce emissions.

In some examples, emissions may be reduced by operating the compression ignition engine as a dual fuel engine which operates using two different fuels, for example, a low reactivity fuel (e.g., natural gas) and a high reactivity fuel (e.g., diesel). In such an example, the engine may have two fuel systems for each of the fuels. Further, the exhaust gas treatment system may include a reductant system so that a reductant can be delivered to an exhaust gas treatment device for reduction of NOx, for example. As such, an amount of space occupied by the engine and exhaust gas treatment system may be increased.

Current state of the art in shipboard electric power generation has LNG—(liquid natural gas) and dual—(LNG and diesel mixture) fueled prime movers, driving generators, operate at a constant speed regardless of load. It should be noted that although “LNG” is frequently used in the art (and will be used in this disclosure) as a shorthand for “natural gas,” the fuel supplied to the cylinders is gaseous, not liquid; the term of art “LNG” derives from customary storage of natural gas in compressed cryogenic liquid form. Constant speed operation is mandated for conventional AC (alternating current) or DC (direct current) power distribution schemes. To support conventional loads on a conventional AC power distribution scheme, a fixed frequency (constant speed of prime mover) must be maintained regardless of load; to support conventional loads on a conventional DC power distribution scheme, a fixed voltage (constant speed of prime mover) must be maintained regardless of load. However, any prime mover has a maximum continuous rated (MCR) load-speed curve that typically coincides with, or approximates, conditions for a minimum specific fuel consumption (SFC) in units of fuel/power at any given load. Therefore, maintaining constant speed regardless of load, under the current state of the art, results in prime movers typically operating away from their load-speed curves, thus, using more fuel and producing more emissions than should be required for any given load.

Diesel engines are currently used in variable-speed power generation, while natural gas- or dual-fueled engines are used in variable-speed mechanical propulsion. Power generation differs from mechanical propulsion in that power generating equipment is subject to step changes in load (due to breakers closing/opening), whereas mechanical propulsion equipment is not in normal operation subject to step changes in load. Indeed, even in cases where mechanical propulsion equipment includes a shiftable gear train or through throttle commands following a cubic propeller-law curve, capable of producing step changes in shaft torque and speed, normal operation of the gear train does not result in step changes of load (torque×speed). The problem of step load changes is difficult to solve even for diesel engines, and is even more challenging for natural gas- or dual-fueled engines due to their generally lower tolerance for transients.

### BRIEF DESCRIPTION

In embodiments, a fuel system is provided for use with a variable speed dual fuel engine. The fuel system comprises a first fuel injector configured for supplying diesel fuel to the engine, a second fuel injector configured for supplying natural gas to the engine, and a fuel controller configured to implement a diesel injection schedule and a natural gas injection schedule based on at least a fuel map, an optimal engine speed, and a current engine speed.

In other embodiments, a variable speed dual fuel engine is configured for driving connection to an electrical generator for electrical power generation. The variable speed dual fuel engine includes a combustion chamber and a fuel system for supplying fuel into the combustion chamber. The fuel system comprises a first fuel injector configured for supplying diesel fuel to the combustion chamber, a second fuel injector configured for supplying natural gas to the combustion chamber, and a fuel controller. The fuel controller is configured to establish an optimization priority and a starting fuel selection, to select one or more fuel maps based upon the optimization priority and the starting fuel selection, to determine an optimal engine speed based at least on the one or more fuel maps and on at least one engine load parameter, and to determine at least one fuel injection schedule for the first fuel injector and for the second fuel injector based on the one or more fuel maps, the optimal engine speed, and a current shaft speed.

In other embodiments, an electrical power generation and distribution system comprises a variable speed dual fuel engine, an electrical generator configured to be driven by the variable speed dual fuel engine, and an electrical power management system connected to monitor and control electrical connection of at least one electrical load to the electrical generator. The variable speed dual fuel engine includes a fuel system that is configured to determine an optimal engine speed based at least on one or more fuel maps and at least one engine load parameter, to determine at least one fuel injection schedule, for delivering at least one of diesel or natural gas to a combustion chamber of the variable speed dual fuel engine, based at least on the one or more fuel maps, the optimal engine speed, and a current shaft speed, and to implement the at least one fuel injection schedule using at least one fuel injector.

In aspects, a method is provided for operating a dual fueled engine at variable speed. The method comprises selecting a diesel fuel map and selecting a natural gas fuel map; obtaining a measurement related to engine load; establishing an optimal engine speed based at least on the fuel maps and on the measurement related to engine load; obtaining a measurement related to current engine speed; and establishing a diesel fuel injection schedule and a natural gas fuel injection schedule for the engine, based at least on the fuel maps, the optimal engine speed, and the measurement related to current engine speed.

In other aspects, a method is provided for operating a dual fueled engine at variable load. The method comprises, in a fuel controller, establishing for steady state conditions a first optimal engine speed at a first offset above a speed corresponding to a first engine load on a first fuel mix fuel map; and, during steady state conditions, causing supply of a first fuel mix into a combustion chamber of the dual fueled engine in order to maintain the first optimal engine speed. In some aspects, the first offset is determined according to a fraction of a potential load on the engine.

In aspects, a method is provided for operating a dual fuel variable speed engine. The method comprises, in a master fuel controller, detecting engine performance variables, operator inputs, and presence or absence of protected conditions; in the master fuel controller, based on the detected variables, inputs, and conditions, selecting a fuel map to be implemented by the master fuel controller and by a slave fuel controller; and, in the master fuel controller, and in the slave fuel controller, implementing the fuel map for supplying a first fuel and a second fuel into the variable speed engine, simultaneously or sequentially.

In aspects, a method is provided for coordinating a variable speed engine with an electrical power management system. The method comprises supplying from the electrical power management system to a fuel controller of the variable speed engine an operator input for redirecting electrical power; in the fuel controller, adjusting a fuel map in response to the operator input; and, in the electrical power management system, redirecting electrical power in response to the operator input.

### DRAWINGS

The invention will be better understood from reading the following description of non-limiting embodiments, with reference to the attached drawings, wherein below:

FIG. 1 is a schematic illustration of a variable voltage and variable frequency power distribution system.

FIG. 2 is a schematic illustration of a variable voltage power distribution system.

FIG. 3 is a schematic illustration of a fuel injection control system of a variable speed engine according to an embodiment of the invention.

FIG. 4 is a schematic illustration of a fuel map selection process implemented by the control system shown in FIG. 3.

FIG. 5 is a schematic illustration of a fuel injection process implemented by the control system shown in FIG. 3.

FIG. 6 is a schematic illustration of a fuel injection scheduling process implemented by the control system shown in FIG. 3.

FIG. 7 is a schematic illustration of a load-control process implemented by an electrical power management system that is associated with a power distribution system and with a fuel injection control system according to an embodiment of the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

Aspects of the invention relate to variable speed power generation. Certain aspects of the invention relate to use of variable speed natural gas-fueled engines for variable speed power generation. Operation of a prime mover at variable speed (frequency) enables system optimization for a given operational priority e.g., fuel use for a given load requirement, reduction of system noise, and optimization for emissions. Thus, variable speed prime mover operation can allow more fuel-efficient power production by enabling a prime mover to better track its MCR curve. Under variable speed operation, typically, engine speed is decreased as load is decreased, and vice versa. In some embodiments of the invention, at reduced loads the prime mover is operated at a speed offset above its MCR curve, to enable load acceptance (ability to take on additional load without exceeding the MCR curve). Using natural gas (LNG), or an LNG-diesel (dual fuel) mix, provides an environmentally-friendly and cost effective fuel for propulsion and power generation in marine vessels and other vehicles and mobile/stationary power production applications.

In aspects of the invention, natural gas alone is burned as the main fuel, either with diesel priming or with spark ignition. In other aspects of the invention, natural gas is burned in mixture with diesel fuel as the pilot fuel (dual fuel). Use of natural gas fuel in a variable speed engine enables improved system efficiencies and fuel cost savings to the operator. The invention uses natural gas, and/or dual fuel, while running a prime mover at variable speeds. In aspects of the invention, a multi-cylinder engine is run with natural gas alone in one or more cylinders, and with dual fuel in one or more other cylinders. In aspects of the invention, one or more cylinders are switched from natural gas to dual fuel, or from dual fuel to natural gas, in response to load transients. In aspects of the invention, variable frequency power is provided from the variable speed engine and generator to a distribution system, which then supplies various power loads for propulsion, power applications and other uses. Typically, loads are fed by power conversion equipment which can operate across a range of input voltages and frequencies.

In aspects of the invention, decoupling electrical load voltages and frequencies from a variable voltage/variable frequency network allows for control of the driven loads and prime mover independently. This enables better optimization of the prime mover for example: fuel consumption, speed points, torque and load points, system response times from various loads, and noise reduction. This optimization allows for improvements in engine loads that reduce engine wear and improve engine life and maintenance between overhaul cycles.

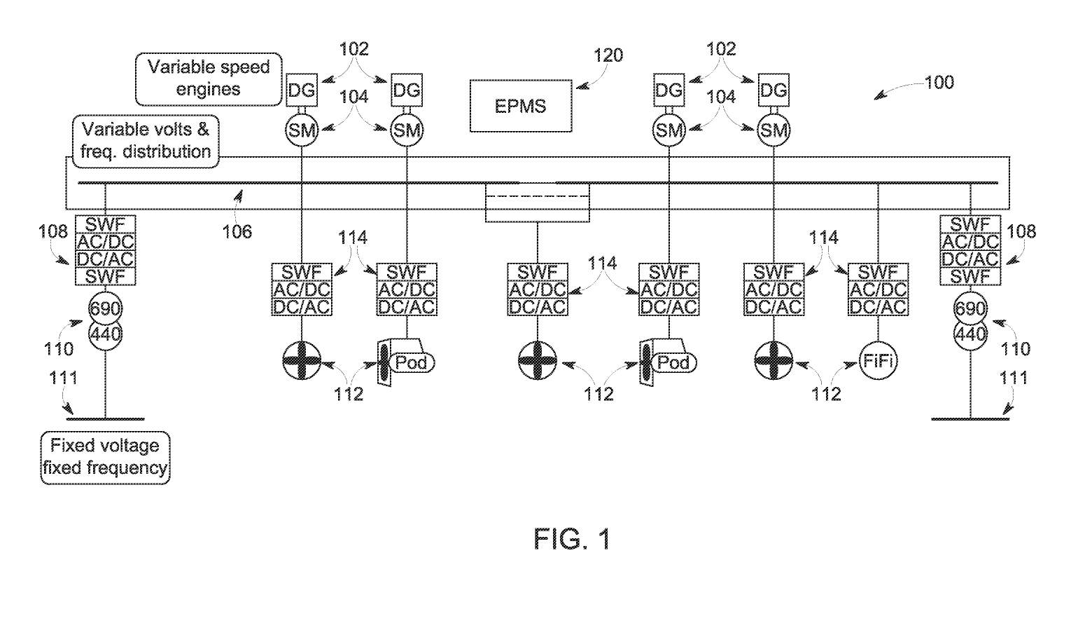

In an exemplary embodiment, as shown in FIG. 1, a variable voltage and variable frequency power distribution system 100 includes plural variable speed natural gas-fueled engines 102. The engines 102 may be fueled solely by natural gas, or by a mixture or combination of natural gas with diesel fuel. A combination of natural gas with diesel fuel may not necessarily be as a mixture, for example, natural gas may be admitted to combustion chambers separately from the diesel fuel, which may be separately injected as a pilot fuel to ignite the natural gas.

For natural gas power generation systems and gensets, different factors need to be considered that are unique to that fuel that need to be pursued to optimize at the various speed and load points. For example, natural gas only burns between 5-15% of oxygen, and at certain operating points, the engines could stall or knock—so switching between dual fuels may be needed to overcome this. A variable speed application has to have this defined for the various particular applications. In particular there is a need to optimize the natural gas fuel maps for a particular application. As variable speed operation can include rapid acceleration/deceleration of engine speed, this can affect which fuels are being used and when in a dual-fuel map. Both the BMEP curve and the air/fuel ratio may need to be optimized. For example, in the event a variable speed genset has a sudden loss of electrical load, the engine needs to have the fuel map optimized to prevent an engine overspeed event due to the rapid decrease of shaft torque. On the other hand, in case there is a sudden increase of electrical load, the engine needs to have the fuel map optimized to prevent an engine stall event due to the rapid increase of shaft torque.

In FIG. 1, each of the plural variable speed natural gas engines 102 drives a mechanically-associated synchronous machine 104, which supplies AC (alternating current) electrical power to a variable voltage, variable frequency main bus 106. Plural filter/power converter assemblies 108 supply electrical power from the main bus 106 to step down transformers or motor generators 110, which in turn supply fixed voltage, fixed frequency AC power to auxiliary busses 111.

Additionally, a plurality of mechanical loads 112 (including, e.g., propellers and azimuthing propulsors) are supplied with electrical power from the main bus 106 via power converters 114. The auxiliary buses 111 may include energy storage systems (e.g., batteries, flywheels; not shown) such that power can alternatively be supplied from one or more of the auxiliary buses, via the corresponding power converter assemblies 108, back to the main bus 106 and to one or more of the various loads 112. An electrical power management system (EPMS) 120 coordinates the power converters 108, 114 to apportion power among the engines 102, the loads 112, and the auxiliary buses 111.

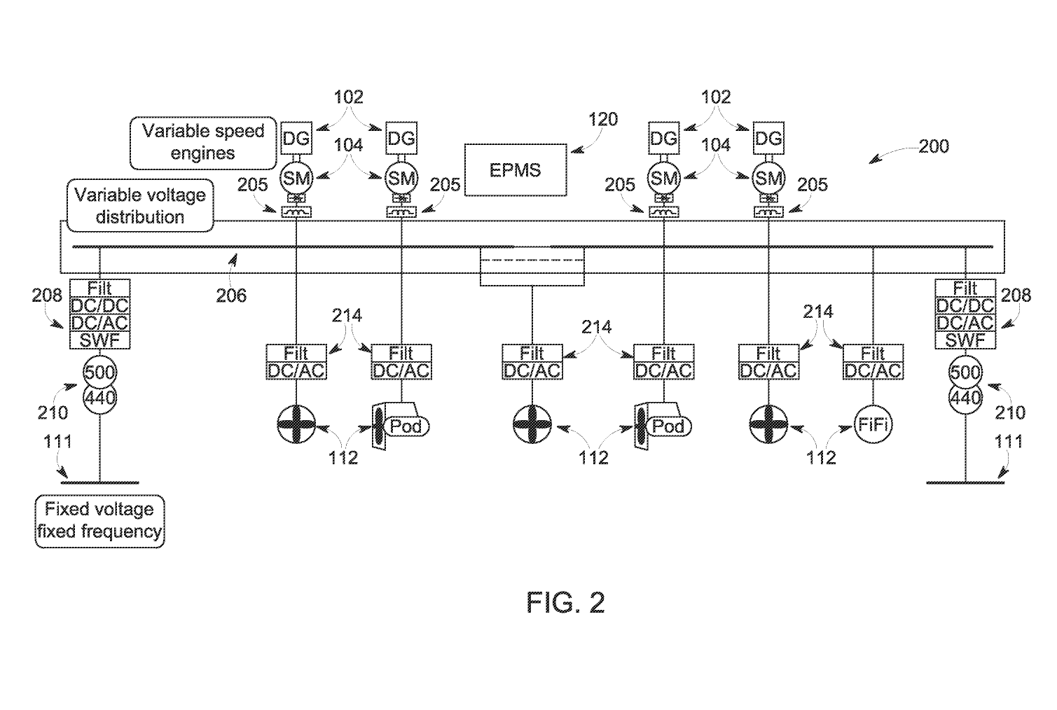

Referring to FIG. 2, in another embodiment, a variable voltage power distribution system 200 includes many of the same components as in FIG. 1. However, inverters 205 are electrically connected between the synchronous machines 104 and a variable voltage DC (direct current) main bus 206. From the main bus 206, plural filter/power converter assemblies 208 supply electrical power to step down transformers or motor generators 210, which in turn supply fixed voltage, fixed frequency AC power to auxiliary busses 111. Additionally, a plurality of mechanical loads 112 (including, e.g., propellers and azimuthing propulsors) are supplied with electrical power from the main bus 106 via power converters 214. Again, power can equally flow from the auxiliary bus(ses) 111 back to the main bus 206, and the flow of power is controlled by the EPMS 120.

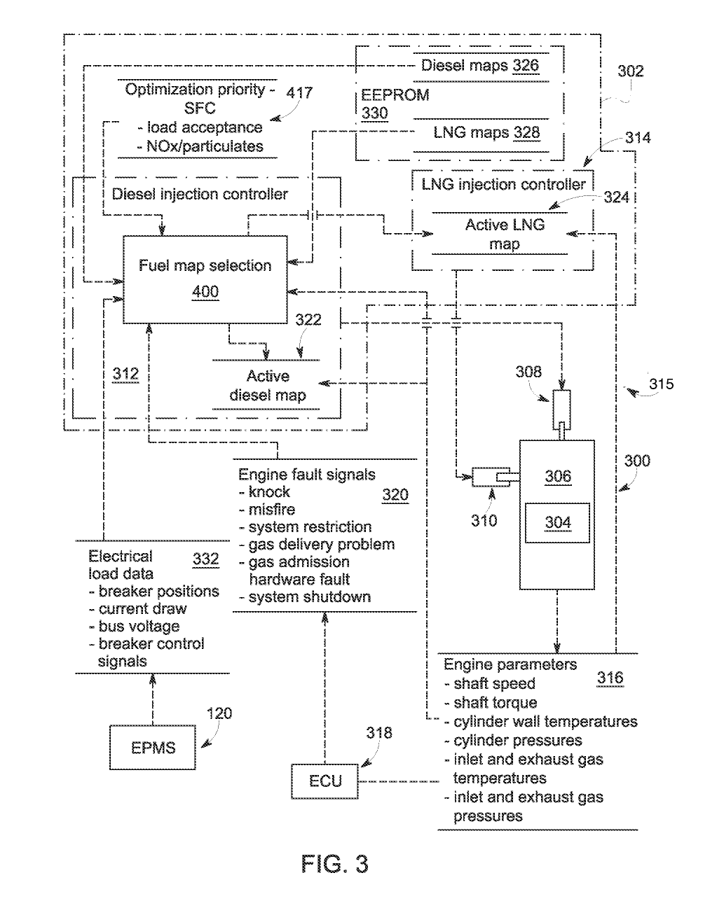

FIG. 3 is a schematic illustration of a variable speed natural gas engine 300, including a fuel controller 302, according to an embodiment of the invention. The engine 300 includes a piston 304 that is operatively connected to turn a crankshaft in conventional manner. The piston 304 defines a combustion volume 306, which has one or more valves (not shown) for respectively ingesting and exhausting air and combustion gases. A diesel fuel supply (not shown) is connected with the cylinder via at least one first injector 308, while a natural gas fuel supply (not shown) is connected with the cylinder via at least one second injector 310. The fuel controller 302 includes a diesel injection controller 312 and a natural gas injection controller 314, which regulate operation of the fuel injectors 308, 310 for scheduled injection of fuel from the fuel supplies into the combustion volume 306. The diesel injection controller 312 is configured as a “master” controller while the natural gas injection controller 314 is configured as a “slave” controller under direction of the diesel injection controller. The fuel controller 302 and the fuel injectors 308, 310 together form an inventive fuel system 315.

Sensors (not shown) measure parameters 316 of the engine 300, including, by way of example, shaft speed; shaft torque; cylinder (combustion volume) wall jacket water temperatures; cylinder pressures; inlet and exhaust gas temperatures through the valves (not shown); and inlet and exhaust gas pressures. Based on the engine parameters 316, an engine control unit (ECU) 318 may generate one or more engine fault signals 320.

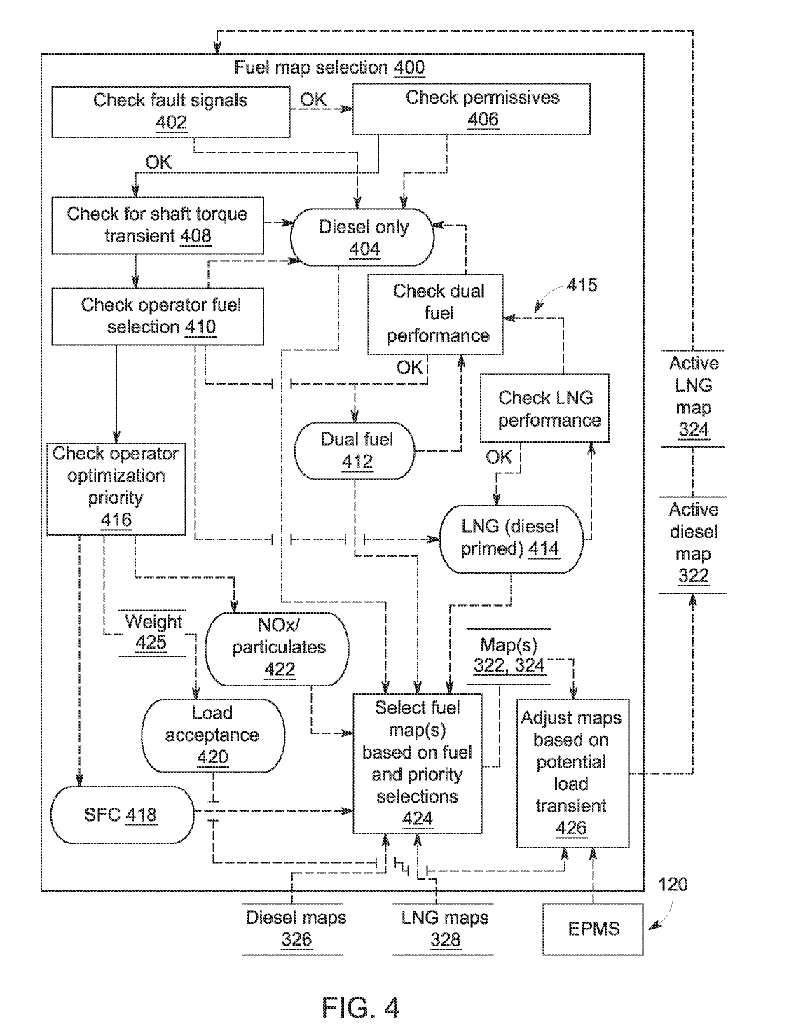

The diesel injection controller 312 periodically uses the engine parameters 316, the engine fault signal(s) 320, if any, and an optimization priority 417 in a fuel map selection process 400 (discussed below with reference to FIG. 4) for selecting an active diesel fuel map 322 and an active natural gas fuel map 324 for use in controlling the respective fuel injectors 308, 310. The diesel injection controller 312 selects the active fuel maps 322, 324 from a plurality of diesel maps 326 and natural gas maps 328 that are stored in an EEPROM 330 (or similar data storage device, as known to those skilled in the art). Also as part of the fuel map selection process 400, the diesel injection controller 312 receives electrical load data 332 from the EPMS 120. Based on the electrical load data 332, the diesel injection controller 312 adjusts the active fuel maps 322, 324 for load acceptance, as further discussed below.

Referring to FIG. 4, the fuel map selection and adjustment process 400 generates the active diesel map 322, used by the diesel injection controller 312, as well as an active natural gas map 324, used by the natural gas injection controller 314. The fuel map selection process 400 includes checking 402 for presence of fault signal(s); if a fault signal is present (not “OK”), then the process branches to “diesel only” 404. If no fault signal is present (“OK”), then the process 400 continues to checking 406 for permissive parameter values (e.g., lube oil at temperature, air available for starting, safety switch closed, etc.) Generally, permissive parameters are go/no go safety items to lockout starting.) In case permissives are “OK” then the process 400 continues to checking 408 for a shaft torque transient. If permissives are not “OK,” or if a shaft torque transient is detected, the process 400 branches to “diesel only” 404. However, if permissives are “OK,” and a shaft torque transient is not detected, then the process 400 continues to checking 410 for an operator fuel selection. The operator fuel selection may be “Diesel only” 404, “Dual Fuel” 412, or “LNG (diesel primed)” 414.

When referring to a “transient” condition, this should be understood to include conditions where a variation or rate of variation of shaft torque exceeds a threshold value that delimits “transient” from “steady state” conditions. An appropriate threshold value can be selected dependent on operational factors such as typical engine loading

While any fuel other than “diesel only” is selected, the process 400 continuously implements a cascading threshold check 415 on certain monitored engine parameters 316 (e.g., shaft speed, shaft torque, exhaust temperature and pressure); in case the monitored engine parameters fail to meet predetermined performance thresholds for the selected fuel mix, then the process 400 defaults down to a fuel mix having less stringent thresholds. For example, in case natural gas is selected, but the engine parameters do not meet natural gas performance thresholds, then the process 400 auto-selects dual fuel mix and checks the engine parameters against relaxed thresholds associated with dual fuel operation. In case the engine parameters do not either meet dual fuel mix performance thresholds, then the process 400 selects “diesel only” and may also produce an operator alert (e.g., text prompt or flashing light or siren) depending upon regulatory requirements for display.

Having selected a fuel type, the process 400 then continues to establish 416 an optimization priority 417 (e.g., by checking for an operator selection of the optimization priority 417; or based on selected engine parameters 316 being within predetermined ranges of values), which may be any of specific fuel consumption (SFC) 418, load acceptance 420, or NOx/particulate emissions reduction 422. Based on the fuel selection 404, 412, or 414 and the optimization priority 418, 420, or 422, the process 400 proceeds to selecting 424 among the available diesel maps 326 and natural gas maps 328.

Depending on an importance or numerical weight 425 that an operator has assigned to “load acceptance,” the process 400 then adjusts 426 the selected fuel maps 322, 324 to account for the electrical load data 332 from the electrical power management system (EPMS) 120. The electrical load data 332 may include such measurements as bus voltage, frequency, and/or total load amperage. Additionally, the electrical load data 332 may include one or more matrixes of open/close positions, operative/inoperative conditions, and/or rated loads of circuit breakers or switches connecting the bus bar 106 with various electrical loads 114 as shown in FIG. 1 or 214 as shown in FIG. 2; as well as control signals for opening or closing breakers or switches, for varying the voltage or frequency of the power converters 108 or 208, or for otherwise adjusting one or more of the electrical loads 114. Thus, the electrical load data 332 can provide both real time and anticipatory control of the fuel selection process 400 in response to current and projected engine loads.

For example, each of the fuel maps 322, 324 may indicate an optimum SFC engine curve, which correlates engine speed to engine load for best (lowest) specific fuel consumption in steady state at each load value. However, the process 400 may upwardly adjust 426 the optimum SFC engine curve, according to a fraction of a largest incremental electrical load (“the potential load,” e.g., one of the 2.5 MW azimuthing thrusters shown in FIGS. 1 and 2) that has not yet been connected to the main bus 106 or 206. Thus, on receipt of a signal to connect the potential load to the electrical bus, e.g., a signal to close a switch for energizing the potential load, the variable speed engine already has sufficient excess speed to absorb an increased shaft torque without stalling. For example, the fraction of the potential load may be 100%; 80%; 60%; and so forth, according to the weight 425 assigned by an operator to “load acceptance.”

Alternatively, instead of adjusting 426 the fuel maps 322, 324, the diesel injection controller 312 may intercept each load control signal, and on receipt of a signal to connect or disconnect any load to the electrical bus, e.g., a signal to close a switch for energizing a load or to open a switch for de-energizing a load, the diesel injection controller 312 may select a new set of fuel maps 322, 324 according to the anticipated load transient. The updated fuel maps then can be implemented by the diesel injection controller 312 and by the natural gas injection controller 314, concurrent with forwarding the load control signal(s) from the diesel injection controller 312 to the switch(es) or power converter(s).

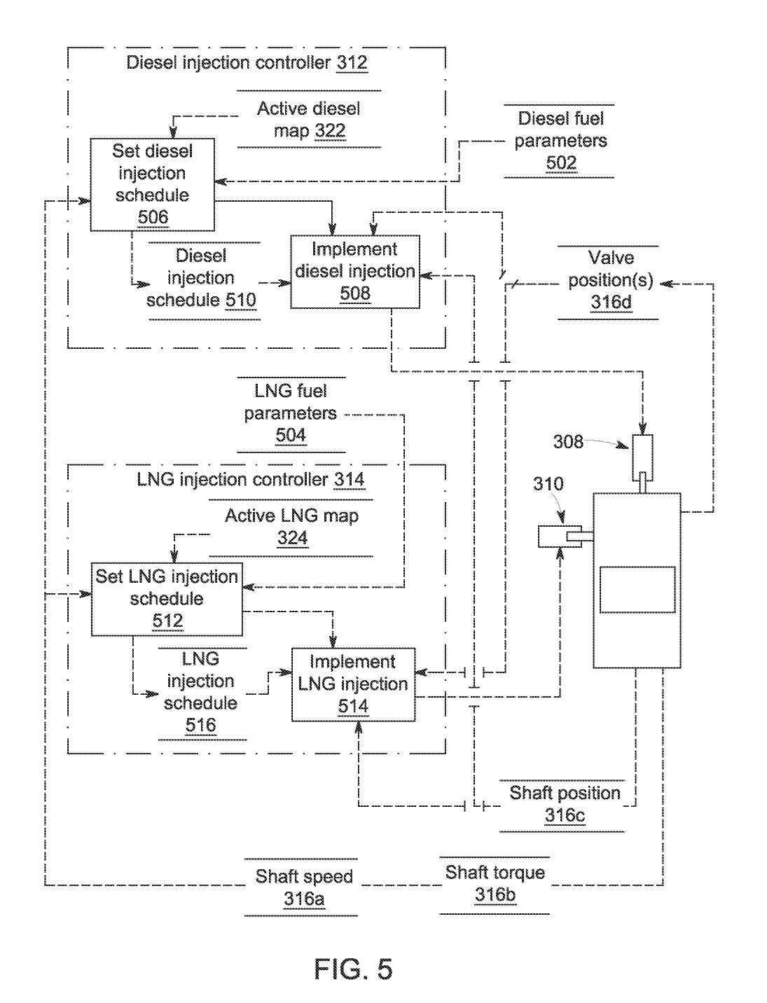

FIG. 5 shows the injection controllers 312, 314 using selected engine parameters 316 (e.g., shaft speed 316a, shaft torque 316b, shaft position 316c, and valve positions 316d for each cylinder), along with diesel fuel parameters 502 and natural gas fuel parameters 504, to set 506 and implement 508 a diesel injection schedule 510 and to set 512 and implement 514 a natural gas injection schedule 516, based on the fuel maps 322, 324, for controlling the respective diesel injector(s) 308 and natural gas injector(s) 310. The diesel fuel parameters 502 may include, for example, temperature, rail pressure, viscosity, and cetane number (for light oil; CCAI or CCI for heavy oil). The natural gas fuel parameters 504 may include, for example, temperature and pressure.

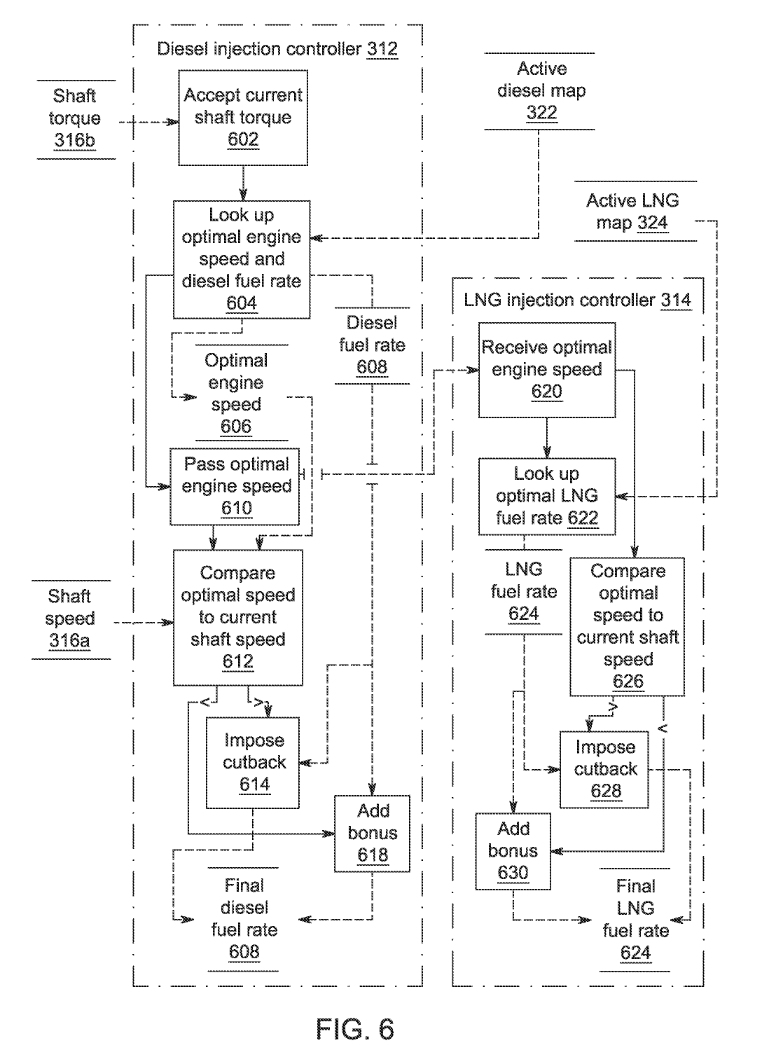

FIG. 6 shows in more detail a process 600, implemented by the diesel injection controller 312 and by the natural gas injection controller 314, for setting the diesel and natural gas injection schedules 510, 516 in response to a change in shaft torque 316b, based on the active diesel fuel map 322 and natural gas fuel map 324. First, the diesel injection controller 312 accepts 602 a current value of the shaft torque 316b. Using the shaft torque 316b, the diesel injection controller 312 determines 604 an optimal engine speed 606 and a corresponding diesel fuel rate 608 (e.g., by looking them up on the diesel fuel map 322) for achieving the optimal engine speed at steady state. Also, the diesel injection controller 312 passes 610 the optimal engine speed 606 to the natural gas injection controller 314. The diesel injection controller 312 then compares 612 the optimal engine speed 606 to a current value of the shaft speed 316a. In case the optimal engine speed 606 is less than the shaft speed 316a, the diesel injection controller 312 imposes 614 a cutback to the diesel fuel rate 608, based on the excess of the shaft speed 316a over the optimal engine speed 606. On the other hand, in case the optimal engine speed 606 is greater than the shaft speed 316a, the diesel injection controller 312 adds 618 a bonus to the diesel fuel rate 608.

Meanwhile, the natural gas injection controller 314 receives 620 the optimal engine speed 606, determines 622 a corresponding natural gas fuel rate 624 for achieving the optimal engine speed at steady state, and compares 626 the optimal engine speed 606 to the shaft speed 316a. In case the optimal engine speed 606 is less than the shaft speed 316a, the natural gas injection controller 314 imposes 628 a cutback to the natural gas fuel rate 624, based on the excess of the shaft speed 316a over the optimal engine speed 606. On the other hand, in case the optimal engine speed 606 is greater than the shaft speed 316a, the natural gas injection controller 314 adds 630 a bonus to the natural gas fuel rate 624, based on the shortfall of the shaft speed 316a from the optimal engine speed 606. Alternatively, in case the optimal engine speed 606 exceeds the shaft speed 316a by more than a preset amount (such that a shaft torque transient would result from ramping speed), then the diesel injection controller 312, in implementing the cascading threshold check 415, will cancel natural gas injection and will implement diesel-only fuel injection for the duration of the speed ramp.

Based on the diesel fuel rate 608, the natural gas fuel rate 624, the shaft speed 316a, the shaft position 316c, and the valve positions 316d, the diesel injection controller 312 and the natural gas injection controller 314 then implement diesel fuel injection 508 and implement natural gas fuel injection 514, as shown in FIG. 5, to achieve efficient fuel burn by the injectors 308, 310.

Thus, in some aspects, it is possible for the diesel injection controller 312 to select appropriate diesel and natural gas fuel maps 322, 324 and optimal engine speed 606 based on current electrical loading, and based also on a maximum anticipated upward step change of electrical loading. For example, the optimal engine speed 606 may be selected to withstand an upward anticipated load transient based on the rated load of the largest breaker not yet closed.

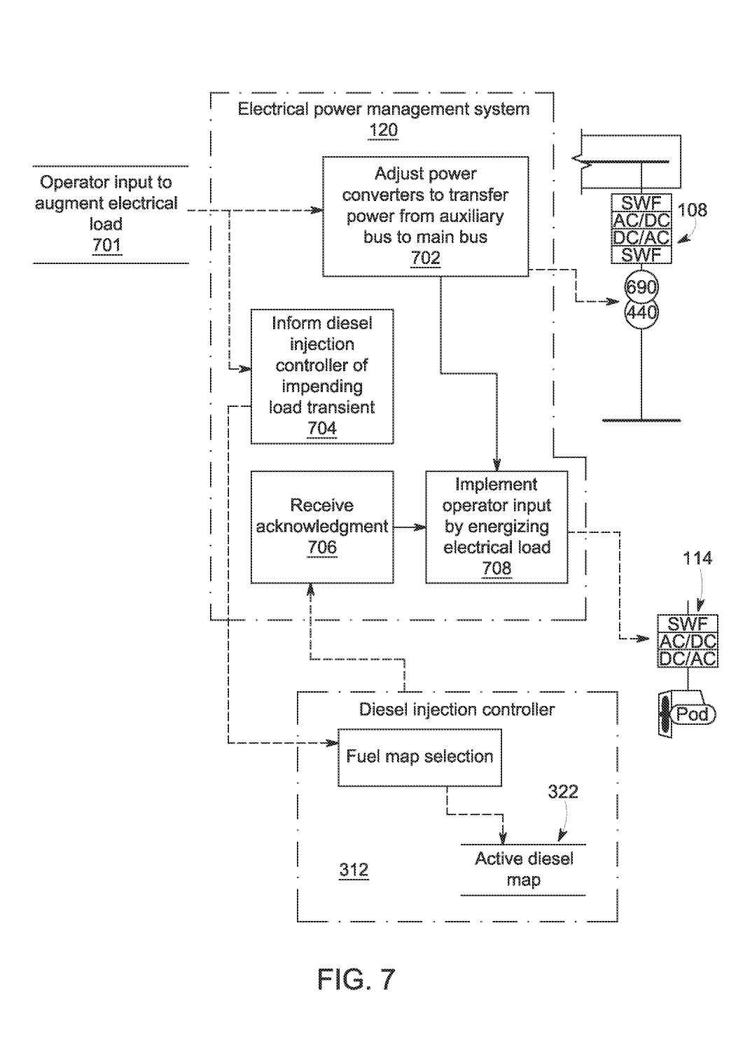

FIG. 7 shows a load control process 700, implemented within the electrical power management system (EPMS) 120, that coordinates the diesel injection controller 312 with one or more power converters 108 in order to smooth step load transients. In case an operator input 701 is received indicative of an impending upward load transient on the main bus 106 (for example, an operator input to energize a large electrical load 114 such as a motor driver for one of the 2.5 MW azimuthing thrusters), then the EPMS 120 adjusts 702 the power converters 108 to transfer electrical power from an auxiliary electrical bus 111 (connected with an energy storage unit, not shown) to the main bus 106, thereby reducing load on the variable speed natural gas engines 102. Simultaneously, the EPMS 120 informs 704 the diesel injection controller 312 of the impending load transient, according to a known starting surge of the large load 114. On receiving 706 a signal from the diesel injection controller 312, then the EPMS 120 implements 708 the operator input 701 by energizing the electrical load 114. The signal from the diesel injection controller 21 may be, for example, an acknowledgment of the load transient; or a confirmation that a fuel map has been adjusted as discussed above with reference to FIG. 4. Alternatively, the EPMS 120 may implement the operator input after expiration of a pre-determined time delay, or after the earlier of the signal from the diesel injection controller or the expiration of the pre-determined time delay.

Thus, in embodiments, a fuel system is provided for use with a variable speed dual fuel engine. The fuel system comprises a first fuel injector configured for supplying diesel fuel to the engine, a second fuel injector configured for supplying natural gas to the engine, and a fuel controller configured to implement a diesel injection schedule and a natural gas injection schedule based on at least a fuel map, an optimal engine speed and a current engine speed. In some embodiments, the fuel controller is configured to establish an optimization priority and a starting fuel selection, to select one or more fuel maps based upon the optimization priority and the starting fuel selection, and to determine the optimal engine speed based at least on the one or more fuel maps and on at least one engine load parameter. For example, the at least one engine load parameter may include any one or more of a shaft torque, a magnitude of a largest potential electrical load, or data from an electrical power management system. In some embodiments, the fuel controller is configured to implement the natural gas injection schedule and a pilot diesel injection schedule during steady state conditions, and to implement the diesel injection schedule during transient conditions. In some embodiments, the fuel controller is configured to implement the natural gas injection schedule in response to an operator input, and to implement the diesel injection schedule during transient conditions.

In other embodiments, an electrical power generation and distribution system comprises a variable speed dual fuel engine, an electrical generator configured to be driven by the variable speed dual fuel engine, and an electrical power management system connected to monitor and control electrical connection of at least one electrical load to the electrical generator. The variable speed dual fuel engine includes a fuel system that is configured to determine an optimal engine speed based at least on one or more fuel maps and at least one engine load parameter, to determine at least one fuel injection schedule, for delivering at least one of diesel or natural gas to a combustion chamber of the variable speed dual fuel engine, based at least on the one or more fuel maps, the optimal engine speed, and a current shaft speed, and to implement the at least one fuel injection schedule using at least one fuel injector. For example, the at least one engine load parameter may include any one or more of data from the electrical power management system, a magnitude of a largest potential electrical load, or a measurement of shaft torque. In some embodiments, the fuel system is configured to implement a natural gas injection schedule with a pilot diesel injection schedule during steady state conditions, and to implement a diesel injection schedule during transient conditions. In some embodiments, the fuel system is configured to implement a natural gas injection schedule with a pilot diesel injection schedule in response to an operator input, and to implement a diesel injection schedule during transient conditions. In certain embodiments, the electrical power generation and distribution system further comprises an energy storage unit connected to supply electrical power during an upward load transient and to store electrical power during a downward load transient.

In other embodiments, a variable speed dual fuel engine is configured for driving connection to an electrical generator for electrical power generation. The variable speed dual fuel engine includes a combustion chamber and a fuel system for supplying fuel into the combustion chamber. The fuel system comprises a first fuel injector configured for supplying diesel fuel to the combustion chamber, a second fuel injector configured for supplying natural gas to the combustion chamber, and a fuel controller. The fuel controller is configured to establish an optimization priority and a starting fuel selection, to select one or more fuel maps based upon the optimization priority and the starting fuel selection, to determine an optimal engine speed based at least on the one or more fuel maps and on at least one engine load parameter, and to determine at least one fuel injection schedule for the first fuel injector and for the second fuel injector based on the one or more fuel maps, the optimal engine speed, and a current shaft speed. In some embodiments, the fuel controller is configured to determine the optimal engine speed based on at least one engine load parameter, which may (for example) include any one or more of an engine shaft torque, a largest potential electrical load, or data from an electrical power management system. In some embodiments, the fuel controller is configured to determine a diesel-primed natural gas fuel injection schedule for steady state conditions and to determine a diesel-only fuel injection schedule for transient conditions. In other embodiments, the fuel controller is configured to determine a diesel-primed natural gas fuel injection schedule in response to an operator input and to determine a diesel-only fuel injection schedule for transient conditions.

In aspects, a method is provided for operating a dual fueled engine at variable speed. The method comprises selecting a diesel fuel map and selecting a natural gas fuel map; obtaining a measurement related to engine load; establishing an optimal engine speed based at least on the fuel maps and on the measurement related to engine load; obtaining a measurement related to current engine speed; and establishing a diesel fuel injection schedule and a natural gas fuel injection schedule for the engine, based at least on the fuel maps, the optimal engine speed, and the measurement related to current engine speed. For example, the measurement related to engine load may include at least one of a shaft torque measurement, a matrix of breaker positions, or an electrical current value. In some aspects, the method further comprises implementing the diesel fuel injection schedule during transient conditions and implementing the natural gas fuel injection schedule during steady state conditions. In other aspects, the method further comprises implementing the diesel fuel injection schedule during transient conditions and implementing the natural gas fuel injection schedule in response to an operator input.

In other aspects, a method is provided for operating a dual fueled engine at variable load. The method comprises, in a fuel controller, establishing for steady state conditions a first optimal engine speed at a first offset above a speed corresponding to a first engine load on a first fuel mix fuel map; and, during steady state conditions, causing supply of a first fuel mix into a combustion chamber of the dual fueled engine in order to maintain the first optimal engine speed. In some aspects, the first offset is determined according to a fraction of a potential load on the engine. In some aspects, during an upward load transient, the fuel controller causes supply into the combustion chamber of a second fuel mix, in order to achieve a second optimal engine speed at a second offset above a speed corresponding to a predicted engine load on the first fuel mix fuel map. In certain aspects, the second fuel mix is selected based at least on engine speed and engine load, according to a second fuel mix map.

In aspects, a method is provided for operating a dual fuel variable speed engine. The method comprises, in a master fuel controller, detecting engine performance variables, operator inputs, and presence or absence of protected conditions; in the master fuel controller, based on the detected variables, inputs, and conditions, selecting a fuel map to be implemented by the master fuel controller and by a slave fuel controller; and, in the master fuel controller, and in the slave fuel controller, implementing the fuel map for supplying a first fuel and a second fuel into the variable speed engine, simultaneously or sequentially.

In aspects, a method is provided for coordinating a variable speed engine with an electrical power management system. The method comprises supplying from the electrical power management system to a fuel controller of the variable speed engine an operator input for redirecting electrical power; in the fuel controller, adjusting a fuel map in response to the operator input; and, in the electrical power management system, redirecting electrical power in response to the operator input. In certain aspects, the electrical power management system implements a pre-determined time delay between receipt of the operator input and redirecting the electrical power. In certain aspects, the electrical power management system delays redirecting electrical power until after receiving a signal from the fuel controller that confirms adjustment of the fuel map. In certain aspects, the electrical power management system delays redirecting electrical power until the earlier of an expiration of a pre-determined time delay or a receipt of a signal from the fuel controller that confirms adjustment of the fuel map.

In an embodiment, a method of operating a dual fueled engine at variable speed comprises selecting a diesel fuel map and selecting a natural gas fuel map, obtaining a measurement related to engine load, establishing an optimal engine speed based at least on the fuel maps and on the measurement related to engine load, obtaining a measurement related to current engine speed, and establishing a diesel fuel injection schedule and a natural gas fuel injection schedule for the engine, based at least on the fuel maps, the optimal engine speed, and the measurement related to current engine speed.

In an embodiment, a method of operating a dual fueled engine at variable speed comprises selecting a diesel fuel map and selecting a natural gas fuel map, obtaining a measurement related to engine load, establishing an optimal engine speed based at least on the fuel maps and on the measurement related to engine load, obtaining a measurement related to current engine speed, and establishing a diesel fuel injection schedule and a natural gas fuel injection schedule for the engine, based at least on the fuel maps, the optimal engine speed, and the measurement related to current engine speed. The measurement related to engine load includes at least one of a shaft torque measurement, a matrix of breaker positions, or an electrical current value.

In an embodiment, a method of operating a dual fueled engine at variable speed comprises selecting a diesel fuel map and selecting a natural gas fuel map, obtaining a measurement related to engine load, establishing an optimal engine speed based at least on the fuel maps and on the measurement related to engine load, obtaining a measurement related to current engine speed, establishing a diesel fuel injection schedule and a natural gas fuel injection schedule for the engine, based at least on the fuel maps, the optimal engine speed, and the measurement related to current engine speed, and implementing the diesel fuel injection schedule during transient conditions and implementing the natural gas fuel injection schedule during steady state conditions.

In an embodiment, a method of operating a dual fueled engine at variable speed comprises selecting a diesel fuel map and selecting a natural gas fuel map, obtaining a measurement related to engine load, establishing an optimal engine speed based at least on the fuel maps and on the measurement related to engine load, obtaining a measurement related to current engine speed, establishing a diesel fuel injection schedule and a natural gas fuel injection schedule for the engine, based at least on the fuel maps, the optimal engine speed, and the measurement related to current engine speed, and implementing the diesel fuel injection schedule during transient conditions and implementing the natural gas fuel injection schedule in response to an operator input.

In another embodiment, a method of operating a dual fueled engine at variable load, comprises, in a fuel controller, establishing for steady state conditions a first optimal engine speed at a first offset above a speed corresponding to a first engine load on a first fuel mix fuel map, and during steady state conditions, causing supply of a first fuel mix into a combustion chamber of the dual fueled engine in order to maintain the first optimal engine speed.

In an embodiment, a method of operating a dual fueled engine at variable load, comprises, in a fuel controller, establishing for steady state conditions a first optimal engine speed at a first offset above a speed corresponding to a first engine load on a first fuel mix fuel map, and during steady state conditions, causing supply of a first fuel mix into a combustion chamber of the dual fueled engine in order to maintain the first optimal engine speed. The first offset is determined according to a fraction of a potential load on the engine.

In an embodiment, a method of operating a dual fueled engine at variable load, comprises, in a fuel controller, establishing for steady state conditions a first optimal engine speed at a first offset above a speed corresponding to a first engine load on a first fuel mix fuel map, and during steady state conditions, causing supply of a first fuel mix into a combustion chamber of the dual fueled engine in order to maintain the first optimal engine speed. During an upward load transient, the fuel controller causes supply of a second fuel mix into the combustion chamber in order to achieve a second optimal engine speed at a second offset above a speed corresponding to a predicted engine load on the first fuel mix fuel map.

In an embodiment, a method of operating a dual fueled engine at variable load, comprises, in a fuel controller, establishing for steady state conditions a first optimal engine speed at a first offset above a speed corresponding to a first engine load on a first fuel mix fuel map, and during steady state conditions, causing supply of a first fuel mix into a combustion chamber of the dual fueled engine in order to maintain the first optimal engine speed. During an upward load transient, the fuel controller causes supply of a second fuel mix into the combustion chamber in order to achieve a second optimal engine speed at a second offset above a speed corresponding to a predicted engine load on the first fuel mix fuel map. The second fuel mix is selected, based at least on the engine load and speed, according to a second fuel mix map.

In another embodiment, a method of operating a dual fuel variable speed engine comprises, in a master fuel controller, detecting engine performance variables, operator inputs, and presence or absence of protected conditions. The method further comprises, in the master fuel controller, based on the detected variables, inputs, and conditions, selecting a fuel map to be implemented by the master fuel controller and by a slave fuel controller. The method further comprises, in the master fuel controller, and in the slave fuel controller, implementing the fuel map for supplying a first fuel and a second fuel into the variable speed engine, simultaneously or sequentially.

In another embodiment, a method of coordinating a variable speed engine with an electrical power management system comprises supplying from the electrical power management system to a fuel controller of the variable speed engine an operator input for redirecting electrical power. The method further comprises, in the fuel controller, adjusting a fuel map in response to the operator input. The method further comprises, in the electrical power management system, redirecting electrical power in response to the operator input.

In an embodiment, a method of coordinating a variable speed engine with an electrical power management system comprises supplying from the electrical power management system to a fuel controller of the variable speed engine an operator input for redirecting electrical power. The method further comprises, in the fuel controller, adjusting a fuel map in response to the operator input. The method further comprises, in the electrical power management system, redirecting electrical power in response to the operator input. The electrical power management system implements a pre-determined time delay between receipt of the operator input and redirecting the electrical power.

In another embodiment, a method of coordinating a variable speed engine with an electrical power management system comprises supplying from the electrical power management system to a fuel controller of the variable speed engine an operator input for redirecting electrical power. The method further comprises, in the fuel controller, adjusting a fuel map in response to the operator input. The method further comprises, in the electrical power management system, redirecting electrical power in response to the operator input. The electrical power management system delays redirecting electrical power until after receiving a signal from the fuel controller that confirms adjustment of the fuel map.

In another embodiment, a method of coordinating a variable speed engine with an electrical power management system comprises supplying from the electrical power management system to a fuel controller of the variable speed engine an operator input for redirecting electrical power. The method further comprises, in the fuel controller, adjusting a fuel map in response to the operator input. The method further comprises, in the electrical power management system, redirecting electrical power in response to the operator input. The electrical power management system delays redirecting electrical power until the earlier of an expiration of a pre-determined time delay or a receipt of a signal from the fuel controller that confirms adjustment of the fuel map.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable one of ordinary skill in the art to practice embodiments of the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal language of the claims.

As used herein, an element or step recited in the singular and proceeded with the word “a” or “an” should be understood as not excluding plural of the elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described charge air cooler cover and thermostat valve, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A fuel system comprising:
a first fuel injector configured for supplying diesel fuel to a variable speed dual fuel engine;
a second fuel injector configured for supplying natural gas to the engine; and
a fuel controller configured to implement a diesel injection schedule and a natural gas injection schedule based on at least a fuel map, an optimal engine speed, and a current engine speed.

2. The fuel system as claimed in claim 1, wherein the fuel controller is configured to establish an optimization priority and a starting fuel selection, to select one or more fuel maps based upon the optimization priority and the starting fuel selection, and to determine the optimal engine speed based at least on the one or more fuel maps and on at least one engine load parameter, wherein the at least one engine load parameter includes a shaft torque.

3. The fuel system as claimed in claim 1, wherein the fuel controller is configured to establish an optimization priority and a starting fuel selection, to select one or more fuel maps based upon the optimization priority and the starting fuel selection, and to determine the optimal engine speed based at least on the one or more fuel maps and on at least one engine load parameter, wherein the at least one engine load parameter includes a magnitude of a largest potential electrical load.

4. The fuel system as claimed in claim 1, wherein the fuel controller is configured to establish an optimization priority and a starting fuel selection, to select one or more fuel maps based upon the optimization priority and the starting fuel selection, and to determine the optimal engine speed based at least on the one or more fuel maps and on at least one engine load parameter, wherein the at least one engine load parameter includes data from an electrical power management system.

5. The fuel system as claimed in claim 1, wherein the fuel controller is configured to implement the natural gas injection schedule and a pilot diesel injection schedule during steady state conditions, and to implement the diesel injection schedule during transient conditions.

6. The fuel system as claimed in claim 1, wherein the fuel controller is configured to implement the natural gas injection schedule in response to an operator input, and to implement the diesel injection schedule during transient conditions.

7. A variable speed dual fuel engine comprising:
a combustion chamber; and
a fuel system for supplying fuel into the combustion chamber, the fuel system comprising:
a first fuel injector configured for supplying diesel fuel to the combustion chamber;
a second fuel injector configured for supplying natural gas to the combustion chamber; and
a fuel controller configured:
to establish an optimization priority and a starting fuel selection,
to select one or more fuel maps based upon the optimization priority and the starting fuel selection,
to determine an optimal engine speed based at least on the one or more fuel maps and on at least one engine load parameter, and
to determine at least one fuel injection schedule for the first fuel injector and for the second fuel injector based on the one or more fuel maps, the optimal engine speed, and a current shaft speed.

8. The variable speed dual fuel engine as claimed in claim 7, wherein the fuel controller is configured to determine the optimal engine speed based on at least one engine load parameter including an engine shaft torque.

9. The variable speed dual fuel engine as claimed in claim 7, wherein the fuel controller is configured to determine the optimal engine speed based on at least one engine load parameter including a largest potential electrical load.

10. The variable speed dual fuel engine as claimed in claim 7, wherein the fuel controller is configured to determine the optimal engine speed based on at least one engine load parameter including data from an electrical power management system.

11. The variable speed dual fuel engine as claimed in claim 7, wherein the fuel controller is configured to determine a diesel-primed natural gas fuel injection schedule for steady state conditions and to determine a diesel-only fuel injection schedule for transient conditions.

12. The variable speed dual fuel engine as claimed in claim 7, wherein the fuel controller is configured to determine a diesel-primed natural gas fuel injection schedule in response to an operator input and to determine a diesel-only fuel injection schedule for transient conditions.

13. The variable speed dual fuel engine as claimed in claim 7, wherein the engine is configured for driving connection to an electrical generator for electrical power generation.

14. An electrical power generation and distribution system comprising:
a variable speed dual fuel engine;
an electrical generator configured to be driven by the variable speed dual fuel engine; and
an electrical power management system connected to monitor and control electrical connection of at least one electrical load to the electrical generator;
wherein the variable speed dual fuel engine comprises a fuel system that is configured:
to determine an optimal engine speed based at least on one or more fuel maps and at least one engine load parameter;
to determine at least one fuel injection schedule, for delivering at least one of diesel or natural gas to a combustion chamber of the variable speed dual fuel engine, based at least on the one or more fuel maps, the optimal engine speed, and a current shaft speed; and
to implement the at least one fuel injection schedule using at least one fuel injector.

15. The electrical power generation and distribution system as claimed in claim 14, wherein the at least one engine load parameter includes data from the electrical power management system.

16. The electrical power generation and distribution system as claimed in claim 15, wherein the data from the electrical power management system includes a magnitude of a largest potential electrical load.

17. The electrical power generation and distribution system as claimed in claim 14, wherein the at least one engine load parameter includes a measurement of shaft torque.

18. The electrical power generation and distribution system as claimed in claim 14, wherein the at least one fuel injection schedule comprises a natural gas injection schedule, a pilot diesel injection schedule, and a diesel injection schedule, and wherein the fuel system is configured to implement the natural gas injection schedule with the pilot diesel injection schedule during steady state conditions, and to implement the diesel injection schedule during transient conditions.

19. The electrical power generation and distribution system as claimed in claim 14, wherein the at least one fuel injection schedule comprises a natural gas injection schedule, a pilot diesel injection schedule, and a diesel injection schedule, and wherein the fuel system is configured to implement the natural gas injection schedule with the pilot diesel injection schedule in response to an operator input, and to implement the diesel injection schedule during transient conditions.

20. The electrical power generation and distribution system as claimed in claim 14, further comprising an energy storage unit connected to supply electrical power during an upward load transient and to store electrical power during a downward load transient.
